(19) United States
(12) Patent Application Publication
(10) Pub. No.: US 2008/0237293 A1
(43) Pub. Date: Oct. 2, 2008

(54) Stapler

(76) Inventor: Yoshiyuki Ebihara, Tokyo (JP)

Correspondence Address: GREENBERG TRAURIG, LLP, 77 WEST WACKER DRIVE, SUITE 2500, CHICAGO, IL, 60601-1732, US

(21) Appl. No.: 11/885,091

(22) PCT Filed: Feb. 27, 2006
(86) PCT No.: PCT/JP06/03631

§ 371 Date: Jun. 3, 2008

(30) Foreign Application Priority Data
Feb. 25, 2005 (JP) 2005-050169
May 17, 2005 (JP) 2005-144784

(51) Int. Cl. B25C 5/06

(52) U.S. Cl. 227/120

(57) ABSTRACT

[Object] To provide a stapler for fastening papers or the like, which can perform a proper stapling operation even though a handle thereof is given smaller force, can perform a stronger stapling operation, can reduce the production cost due to fewer parts and simple structure, and has a structure in which a structure in which staples does not accidentally pop out when refilling staples.

[Solve] By pushing down a handle, a trigger member moves a puller or pusher member, and the movement of the puller or pusher member moves a fulcrum shaft B, which results in that an angle formed by a fulcrum shaft A, the fulcrum shaft B, and a fulcrum shaft C becomes closer to 180 degrees. In accordance with this, one end of a driver spring moves to the upper side to save power in the driver spring, and by pushing down the handle, the engagement between the trigger member and the puller or pusher member is released. This extinguishes the force for moving the fulcrum shaft B to move the fulcrum shaft B, and the lifting down of the fulcrum shaft A lifts down a blade attached to one end of the driver spring, which results in a stapling operation.

### TECHNICAL FIELD

The present invention relates to a stapler for fastening papers or the like.

### TECHNICAL BACKGROUND

Patent Reference 1: U.S. Pat. No. 6,145,728

### DISCLOSURE OF THE INVENTION

### Problem to be Solved by the Invention

An object of the present invention is to provide a stapler for fastening papers or the like, which can perform a proper stapling operation even though a handle thereof is given smaller force. Another object of the present invention is to provide a stapler which can perform a strong stapling operation even though a handle thereof is given smaller force.

Another object of the present invention is to provide a stapler having fewer parts and simple structure.

Yet another object of the present invention is to provide a stapler which prevents an accident that staples are coming out due to strong force to pushing out staples when refilling staples. In other word, it is an object to provide a stapler having a structure in which a mechanism to push out staples does not function when refilling staples.

A stapler for fastening papers or the like, which can perform a proper stapling operation even though a handle thereof is given smaller force had always been desired. Until today, many prior arts were disclosed as the mechanism to solve such problem.

A stapler, so called Tacker system stapler, which needs smaller force to staple is described in U.S. Pat. No. 6,145,728. However, the stapler described in U.S. Pat. No. 6,145,728 has a structure in which a base is opened under the condition that staples is being pushed by a feeder when refilling staples. Therefore, it is very dangerous that staples protrude due to the fall down of the handle. In addition, if a stapler can strike staples with stronger force than the one of the stapler described in U.S. Pat. No. 6,145,728, it is better in the point that the volume of an object to be fasten can be increase.

### Means for Solving Problem

One aspect of the invention provides a stapler comprising a handle member, a frame member of which a rear end is pivotably attached to the handle member, a base member of which a rear end is pivotably attached to the frame member and on which is mounted a guide member, a feeder member which is linked to the guide member via spring, and pushes a staple which slides along the guide forward by engaging a rail provided on the frame member and sliding back and forth with spanning the guide member, a driver spring member of which one end is attached to a blade member and another end is attached to the frame member, a toggle mechanism having a joint a of which one end is a fulcrum shaft A and another end is a fulcrum shaft B, and a joint b of which one end is a fulcrum shaft B and another end is a fulcrum shaft C, the other end of the joint a is pivotably attached to one end of the joint b, a puller member of which the one end engages the fulcrum shaft B, and a trigger member of which one end is pivotably attached to the handle member and the distal of another end engages the puller member, wherein the driver spring member engages the fulcrum shaft A at a place between one end thereof and another end thereof, the trigger member rotates to push the puller member forward due to the pushing down of the handle, the fulcrum shaft B moves due to the going forward of the puller member, consequently a distance between the fulcrum shaft A and the fulcrum shaft C increases, in accordance with this, one end of the driver spring moves to the upper side to save power in the driver spring, further pushing down of the handle releases the engagement between the dismal of the trigger member and the puller member and the power saved in the driver spring is temporally released to lift down the fulcrum shaft A, and the lifting down of the fulcrum shaft A lifts down the blade attached to one end of the driver spring.

By the engagement between the guide member and the base member, when refilling staples, the base and the guide integrally open. This prevents a staple going out due to an accidental lifting down of the handle.

Another aspect of the invention provides the stapler in which the trigger member rotates to push the puller member backward due to the pushing down of the handle, the fulcrum shaft B moves backward due to the rearward movement of the puller member, consequently a distance between the fulcrum shaft A and the fulcrum shaft C increases. This mechanism is described in such as Embodiment 1.

Yet another aspect of the invention provides the stapler in which the fulcrum shaft B is always located forward of a line linking the fulcrum shaft A and the fulcrum shaft C.

The fulcrum shaft B is always located forward of a line linking the fulcrum shaft A and the fulcrum shaft C means a condition that the toggle mechanism is in V-shape with being opened rearward in the side view as shown in FIG. 3 to FIG. 12. This structure allows the stapler to return the condition before stapling operation after striking staples.

Yet another aspect of the invention provides the stapler in which a lower side projection is provided forward of the distil of the other end of the trigger member, the lower side projection of the trigger member keeps the engagement with the puller member continuously even after the engagement between the distil of the trigger member and the puller member is released, the extinguishment of the force for pushing down the handle lifts up the forward of the handle, in accordance with the lifting up of the forward of the handle, the trigger member rotates around one end of the trigger member to lift down another end of the trigger member, in accordance with the lifting down of the other end of the trigger member, the position of the engagement between the trigger member and the puller member moves forward, and the distil of the trigger member engages the puller member again.

The term “another end” of the trigger member is used as a word corresponding to “one end” of the trigger member. That is, it is the one of two ends of the trigger member that is not pivotably attached to the handle. The term “lower end” refers to an end positioned at the lower side when the trigger member is specified in the condition shown in FIG. 11. In the embodiment, a part indicated as numeral 13 corresponds to the lower end.

Another aspect of the invention provides the stapler in which the trigger member rotates to push the puller member forward due to the pushing down of the handle, the fulcrum shaft B moves forward due to the forward movement of the puller member, consequently a distance between the fulcrum shaft A and the fulcrum shaft C increases. This mechanism is described in such as Embodiment 2.

Yet another aspect of the invention provides the stapler in which the fulcrum shaft B is always located rearward of a line linking the fulcrum shaft A and the fulcrum shaft C.

The fulcrum shaft B is always located rearward of a line linking the fulcrum shaft A and the fulcrum shaft C means a condition that the toggle mechanism is in V-shape with being opened forward in the side view as shown in FIG. 14 to FIG. 16. This structure allows the stapler to return the condition before stapling operation after striking staples.

Another aspect of the invention provides the stapler in which the lower side projection is provided rearward of the distil of the other end of the trigger member, the lower side projection of the trigger member keeps the engagement with the puller member continuously even after the engagement between the distil of the trigger member and the puller member is released, the extinguishment of the force for pushing down the handle lifts up the forward of the handle, in accordance with the lifting up of the forward of the handle, the trigger member rotates around one end of the trigger member to lift down the other end of the trigger member, in accordance with the lifting down of the other end of the trigger member, the position of the engagement between the trigger member and the puller member moves forward, and the distil of the trigger member engages the puller member again.

### EFFECT OF THE INVENTION

According to the present invention, a stapler which can perform a proper and stronger stapling operation with smaller force is provided. In other words, a toggle mechanism converts a smaller force for pushing a handle to a stronger force for striking a blade, which results in a proper and stronger stapling operation.

Furthermore, fewer parts and simple structure reduce the production cost.

Moreover, when refilling staples, it is safety since a structure in which a mechanism for pressing out staples does not function.

### THE BEST MODE FOR CARRYING OUT THE CLAIMED INVENTION

To explain the present invention, a side where a blade is positioned refers to “forward”, a side where a base and a frame, and the frame and a handle are pivotably attached refers to “rearward”, a side the handle is positioned refers to “upper side”, and a side the base is positioned refers to “lower side”.

### Embodiment 1

A schematic view of a stapler with respect to Embodiment 1 is as shown in FIG. 1. In other words, a stapler 1 has a base 2, a frame 4 to which the base 2 is pivotably attached, a handle 3 to which the frame 4 is pivotably attached. The force of a spring provided at a place between the base 2 and the frame 4 (not shown in the figure), works in the direction for separating the base 2 and the frame 4.

FIG. 2 and FIG. 3 explain the components of the stapler. A guide 45 is pivotably attached to the lower side of the frame 4 on the rearward of the frame. A guide-base engaging unit 47 of the guide 45 engages the base 2. This allows integral rotation of the base 2 and the guide 45 when refilling staples, so that the base and the guide open with being apart from the frame. A staple (not shown in the figure) slides on the guide 45.

A feeder-frame engaging unit 42 of the feeder 40 engages a rail mechanism of an inner wall of the frame (not shown in the figure), and the feeder slides back and forth along the rail mechanism. A spring is provided at a place between a feeder-spring engaging unit 41 provided on the feeder and a guide-spring engaging unit 46 provided on an inner wall of the guide (not shown in the figure). The feeder 40 is mounted so as to span the guide 45, and is placed at the side where the staple towards by the force of the spring.

Referring to FIG. 2 and FIG. 3, the rearward portion of the driver spring 30 is fixed to the frame 4 (in the figure, with screws). The driver spring 30 is comprised of flexible material and functions as a blade spring. A forward projection 32 of the driver spring 30 engages a blade opening 36 of the blade 35, and a blade engagement 37 of the upper side of the blade engages a forward projection 32 of the driver spring, which makes the blade 35 hardly dropping off from the driver spring.

A toggle mechanism 50 is pivotably attached to an upper side projection 31 of the driver spring 30. The toggle mechanism 50 includes a joint A 51 and a joint B 52, the joint B 52 is pivotably attached to the joint A 51 by a toggle shaft 54. The joint A 51 is pivotably attached to the driver spring 30 by a toggle driver spring shaft 53, and the joint B 52 is pivotably attached to the inner wall of the frame 4 by a toggle frame pin 55. A puller 20 is pivotably attached to the toggle shaft 54. The puller 20 has a stopper 22 on the upper surface thereof.

A trigger 10 is pivotably attached to the inner wall of the handle 3. The trigger 10 has a base member 11 pivotably attached to the handle 3, a tongue A 12 which is going to engage the stopper 22 of the puller 20 by operation, and a tongue B 13 which is going to engage the upper surface of the puller 20 by operation. A torsion spring is provided at a place between the upper surface of the trigger 10 and the inner wall of the handle 3 (not shown in the figure). Due to the torsion spring, a force setting apart the trigger 10 and the handle 3 work.

FIG. 3 to FIG. 11 show effects of the stapler. FIG. 3 shows a condition before operation. FIG. 4 shows a condition in which the handle is pushed down in the direction indicated by an arrow A, the tongue A 12 at the end of the trigger 10 slides on the upper surface of the puller 20 rearward slightly, and the tongue A 12 comes to engage the stopper 22 of the puller 20. After then, by further pushing down the handle 3 in the direction indicated by the arrow A, the tongue A 12 at the end of the trigger 10 pushes the stopper 22, that is, the puller rearward. The side walls of the puller 20 slides a window 77 (FIG. 13) of the frame. FIG. 5 shows a condition of the puller 20 when an altitude between the base member 11 of the trigger and the frame decreases 5 mm by pushing down the handle, FIG. 6 shows a condition that the altitude decreases 10 mm, FIG. 7 shows a condition that the altitude decreases 15 mm, FIG. 8 shows a condition that the altitude decreases 20 mm, FIG. 9 shows a condition that the altitude decreases 25 mm, and FIG. 10 shows a condition that the altitude decreases 30 mm. Corresponding to that the tongue A 12 of the trigger 10 pushes down the stopper 22 of the puller 20 rearward, the base member 21 of the puller 20 guides the toggle shaft 54 rearward, which results in that the toggle mechanism which is bent in L shape becomes straight. Corresponding to that the bent toggle mechanism becomes straight, a toggle driver spring shaft 53 moves to the upper side. Along with the upper side movement of the toggle driver spring shaft 53, the forward of the driver spring 30 lifts up and the blade 35 moves to the upper side accordingly. The thickness of the blade 35 is as same as one staple, a staple 38 goes forward for one stapler distance due to the push of the feeder 40 since the blade 35 moved to the upper side.

In the condition shown in FIG. 8, the tongue B 13 of the trigger 10 comes to engage the upper surface of the puller 20, and by further pushing down the handle 3, the tongue A 12 of the trigger 10 moves in the direction which goes up with setting the tongue B 13 as a fulcrum shaft, (FIG. 8, FIG. 9, and FIG. 10), and just after the condition shown in FIG. 10, the engagement between the tongue A 12 and the stopper 22 is released. The release of the engagement between the trigger 10 and the stopper 22 makes the puller 20 go forward to flip the forward of the driver spring 30. This leads the blade 35 engaging the forward of the driver spring 30 push out a staple 38 with strong force, and a stapling operation is completed. A power saved in the driver spring 30 is based on a power for pushing down the handle, and its magnitude is several times larger than the one for pushing down the handle by the toggle mechanism.

And then, by stopping pushing down the handle in the direction indicated by the arrow A, the stapler returns to the condition before operation (FIG. 3) due to a torsion spring (not shown in the figure) and a spring (not shown in the figure). At that time, as the above-mentioned, L shape bend was straighten by the lifting up of the toggle driver spring shaft 53 of the toggle due to the pushing down of the handle, but a force of the trigger for pushing the puller rearward stops before the bend completely straightens, so that the angle of the rearward of L shape is less than 180 degree. In other words, the bend direction of L shape is maintained. This allows the puller 20 to move forward by the lifting down of the driver spring 30 when the toggle driver spring shaft lifts down, so that the stapler returns to the initial condition.

FIG. 12 shows an effect of the stapler 1 when refilling staples. When refilling staples, the base 2 and the guide 45 are open by rotating around the pivotably attached part to the frame 4. In this regard, since a feeder-spring engaging unit 41 of the feeder 40 and a guide-spring engaging unit 46 of the guide 45 are linked through the spring (not shown in the figure), the feeder 40 moves rearward by the spring along with that the guide 45 goes away from the frame 4. This prevents an accidental popping-out of the staple in case that the handle lifts down in the both cases that leftover staple is in the cartridge and during staple refilling.

FIG. 13 to FIG. 16 shows Embodiment 2. In the Embodiment 1, the puller goes backward to pull the center portion of the toggle mechanism rearward, which results in the power saved in the driver spring through the toggle mechanism, to the contrary, Embodiment 2 has a structure that the pusher go forward to push the center portion of the toggle mechanism forward, which results in the power saved in the driver spring through the toggle mechanism. In other points, generally there is no difference between the Embodiment 1 and the Embodiment 2.

Referring to FIG. 13 and FIG. 14, the compositions of the stapler with respect to the Embodiment are explained. The guide 45 is pivotably attached to the frame via hole located on the rear end of the guide 45, and a frame shaft 43 and a hole 80 of the frame. A guide-base engaging unit 47 engages a cut-out 79 of the frame 4. This allows integral rotations of the base and the guide 45 when refilling staples, which results in that the base and the guide open with being away from the frame. The staple (not shown in the figure) slides on the guide 45.

The feeder-frame engaging unit 42 of the feeder 40 engages a groove 82 on the inner wall of the frame, and the feeder 40 slides fore and rear direction along the groove 82. A spring (not shown in the figure) is provided at a place between the feeder-spring engaging unit 41 provided on the feeder and the guide-spring engaging unit 46 provided on the inner wall of the guide. The feeder 40 is mounted so as to span the guide 45, and is placed at the side where the staple towards by the force of the spring.

The rearward portion of the driver spring 30 is fixed with screws to the frame 4. Apertures 78 for screws are provided on the frame 4. The driver spring 30 is comprised of flexible material and functions as a blade spring. A forward projection 32 of the driver spring 30 engages a blade opening 36 of the blade 35, which allows the blade 35 to move together with the driver spring.

A toggle mechanism 50 is pivotably attached to the upper side projection 31 of the driver spring 30. The toggle mechanism 50 includes a joint A 51 and a joint B 52, and the joint B 52 is pivotably attached to the joint A 51 by a toggle shaft 54. The joint A 51 is pivotably attached to the driver spring 30 by a toggle driver spring shaft 53, and the joint B 52 is pivotably attached to the hole 76 of the inner wall of the frame 4 through a trigger shaft 74. The both ends 65 of the toggle shaft 54 engage a fore end 63 of a pusher 60, and the pusher 60 has a stopper 62 on the upper surface thereof.

A trigger 70 is pivotably attached to the inner wall of the handle 3. The trigger 70 has a base member 71 pivotably attached to the handle 3, a tongue A 72 which is going to engage the stopper 62 of the pusher 60 by operation. A torsion spring is provided at a place between the upper surface of the trigger 70 and the inner wall of the handle 3 (not shown in the figure). Due to the torsion spring, a force setting apart the trigger 70 and the handle 3 works.

FIG. 14 to FIG. 16 show effects of the staple. FIG. 14 shows a condition before operation. FIG. 15 shows a condition in which the handle is pushed down in the direction indicated by an arrow A, the tongue A 72 at the end of the trigger 70 moves the pusher 60 forward via stopper 62 on the top thereof. As a result, the toggle mechanism which was bent in L shape extends to be straight because the pusher 60 pushes the center thereof forward. Correspondingly, the toggle driver spring shaft 53 moves to the upper side. In accordance with the upper movement of the lifting up movement of the toggle driver spring shaft 53, the forward of the driver spring 30 lifts up and the blade 35 moves to the upper side accordingly. The thickness of the blade 35 is as same as one staple, a staple 38 goes forward for one stapler distance due to the press of the feeder 40 since the blade 35 moved to the upper side.

Just after the condition shown in FIG. 15, the engagement between the tongue A 72 and the stopper 62 is released. The release of the engagement between the trigger 70 and the stopper 62 makes the pusher 60 go backward to flip the forward of the driver spring 30. This leads the blade 35 engaging the forward of the driver spring 30 push out a staple 38 with strong force, and a stapling operation is completed. A power saved in the driver spring 30 is based on a power for pushing down the handle, and its magnitude is several times larger than the one for pushing down the handle by the toggle mechanism.

And then, by stopping pushing down the handle in the direction indicated by the arrow A, the stapler returns to the condition before operation (FIG. 14) due to a torsion spring (not shown in the figure) and a spring (not shown in the figure). At that time, as the above-mentioned, L shape bend was straighten by lifting up of the toggle driver spring shaft 53 of the toggle due to the pushing down of the handle, but a force of the trigger for pushing the pusher forward stops before the bend completely straightens, so that the angle of the forward of L shape is less than 180 degree. In other words, the bend direction of L shape is maintained. This allows the pusher 60 to move backward by the lifting down of the driver spring 30 when the toggle driver spring shaft lifts down, so that the stapler returns to the initial condition.

### FIELD OF INDUSTRIAL APPLICATION

It is usable for a stapler for fastening papers or the like. It can be used for not only an existing type stapler which is refilled only staples but also a cassette type stapler of which staples and a staple magazine is integrated.

### BRIEF DESCRIPTION OF THE DRAWINGS

FIG. 1 is a schematic view of a stapler according to Embodiment 1 of the present invention.

FIG. 2 shows each component of the stapler according to Embodiment 1 of the present invention.

FIG. 3 shows an effect of the stapler according to Embodiment 1 of the present invention.

FIG. 4 shows an effect of the stapler according to Embodiment 1 of the present invention.

FIG. 5 shows an effect of the stapler according to Embodiment 1 of the present invention.

FIG. 6 shows an effect of the stapler according to Embodiment 1 of the present invention.

FIG. 7 shows an effect of the stapler according to Embodiment 1 of the present invention.

FIG. 8 shows an effect of the stapler according to Embodiment 1 of the present invention.

FIG. 9 shows an effect of the stapler according to Embodiment 1 of the present invention.

FIG. 10 shows an effect of the stapler according to Embodiment 1 of the present invention.

FIG. 11 shows an effect of the stapler according to Embodiment 1 of the present invention.

FIG. 12 shows an effect of the stapler according to Embodiment 1 of the present invention.

FIG. 13 shows an effect of a stapler according to Embodiment 2 of the present invention.

FIG. 14 shows an effect of the stapler according to Embodiment 2 of the present invention.

FIG. 15 shows an effect of the stapler according to Embodiment 2 of the present invention.

FIG. 16 shows an effect of the stapler according to Embodiment 2 of the present invention.

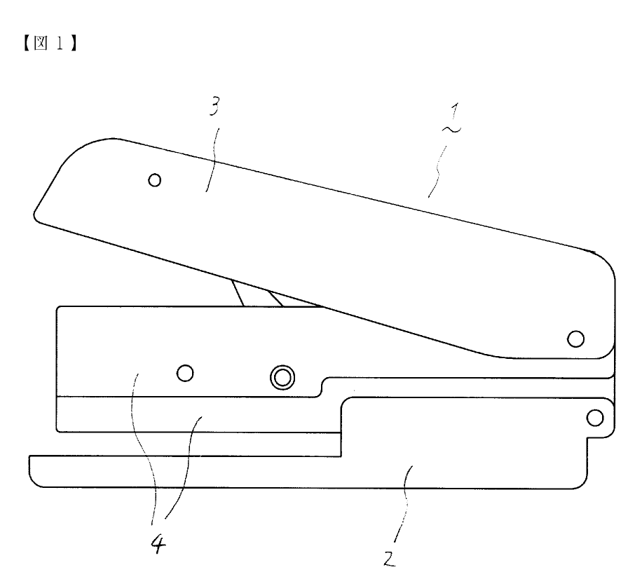

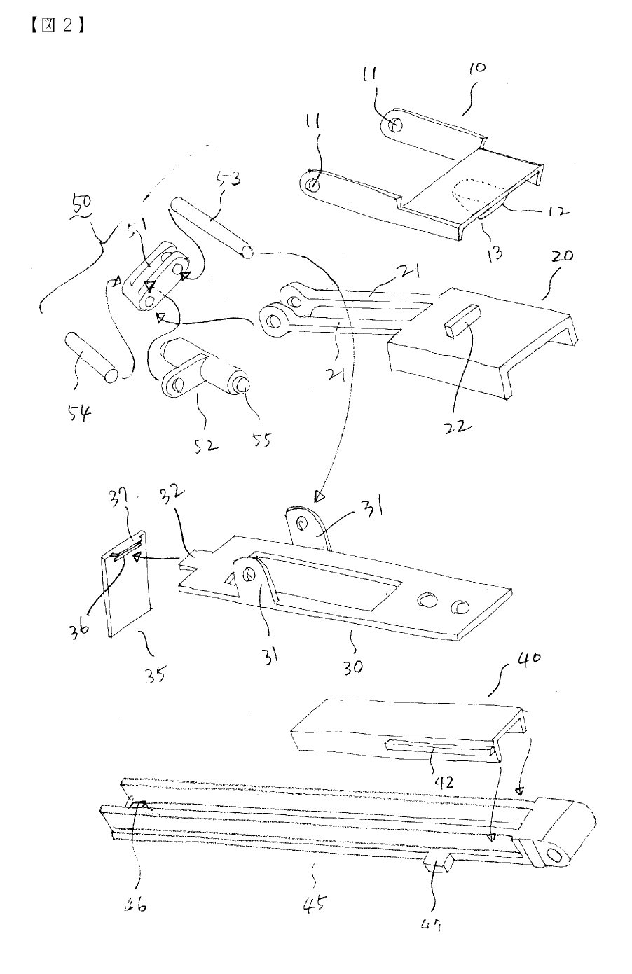

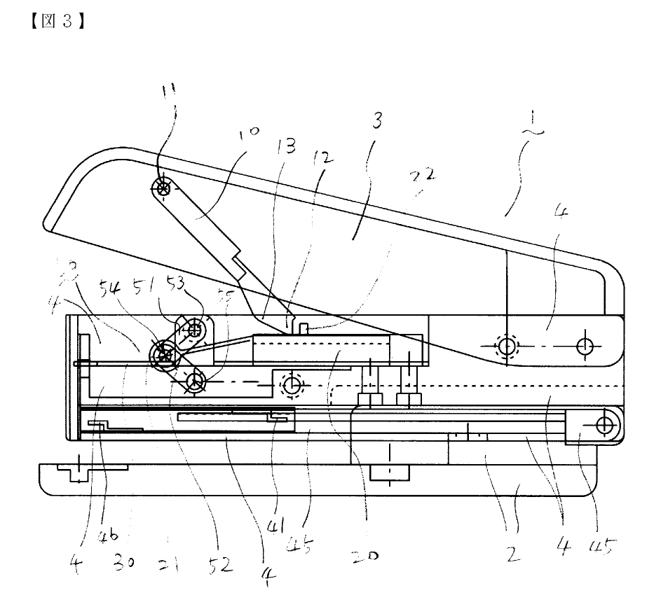

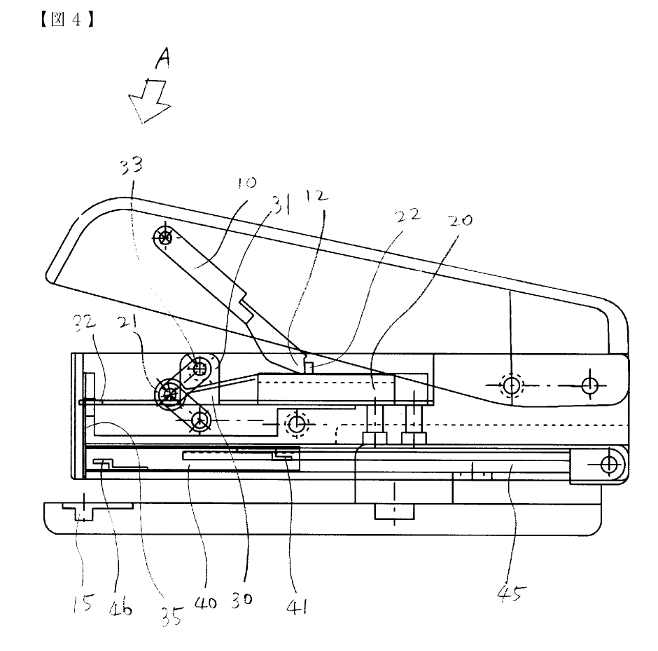

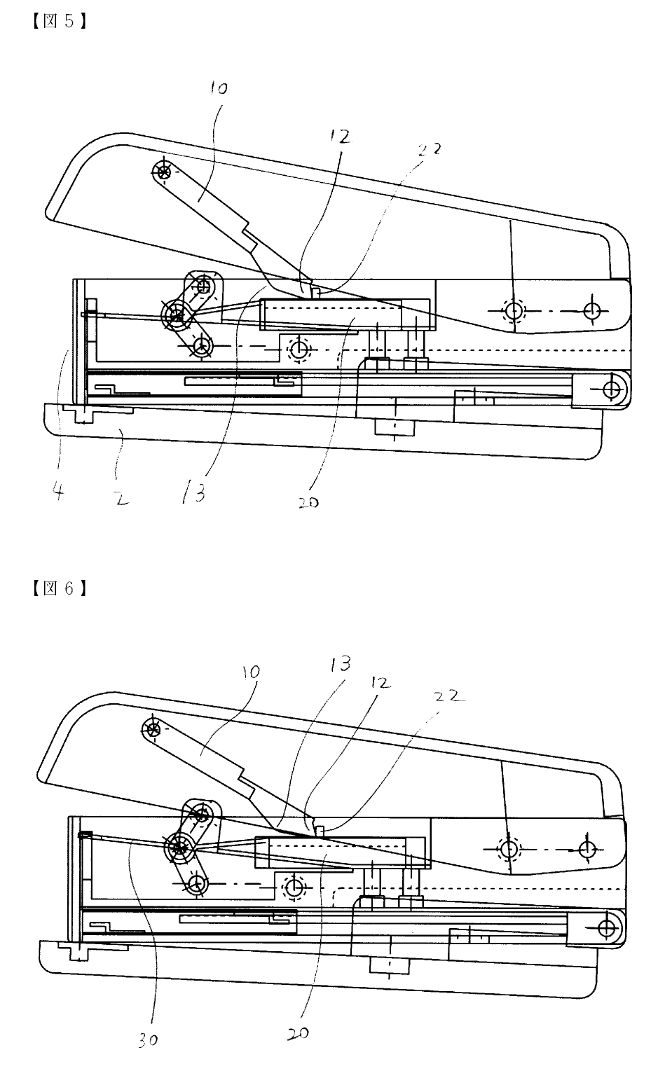

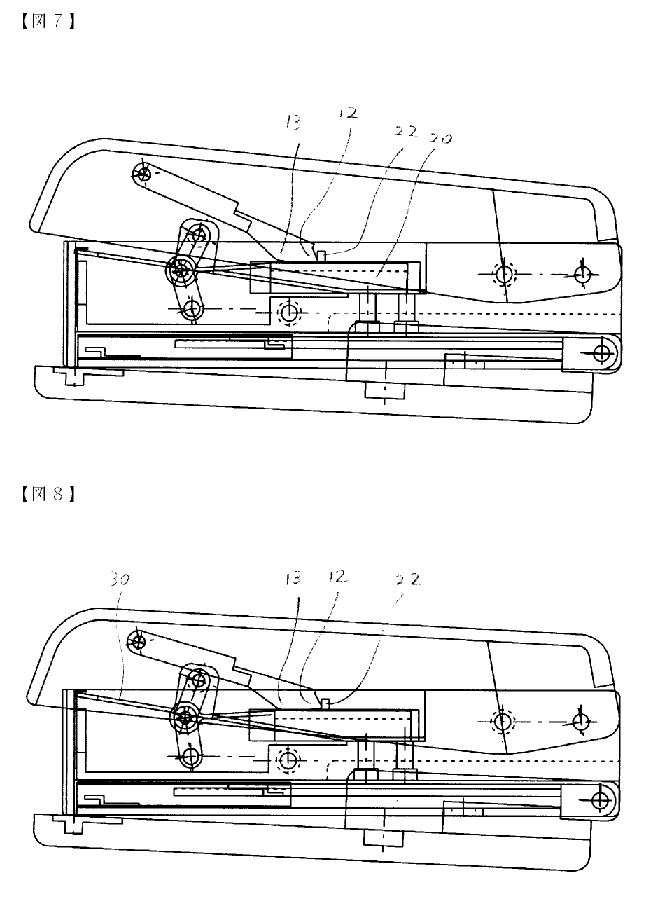

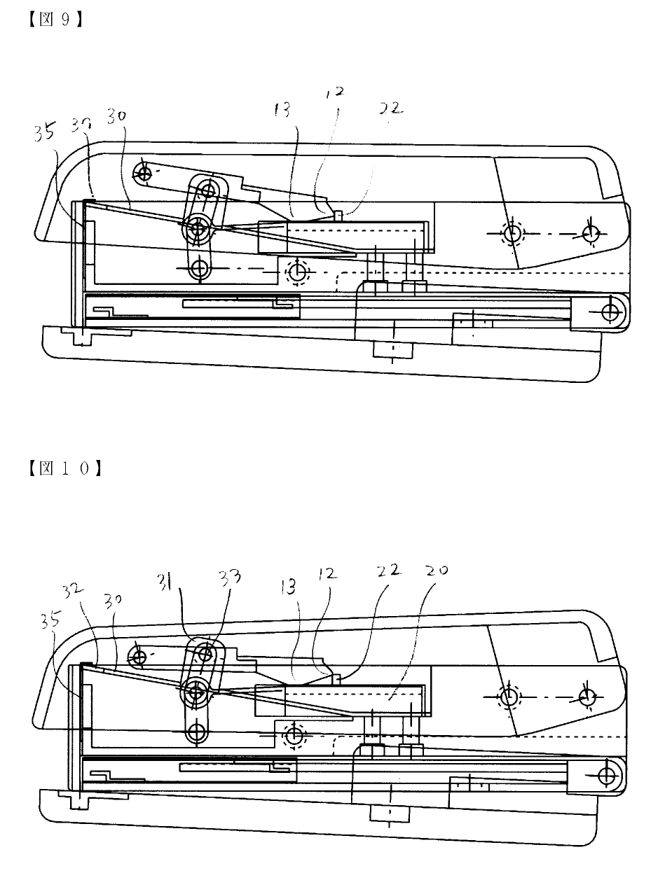

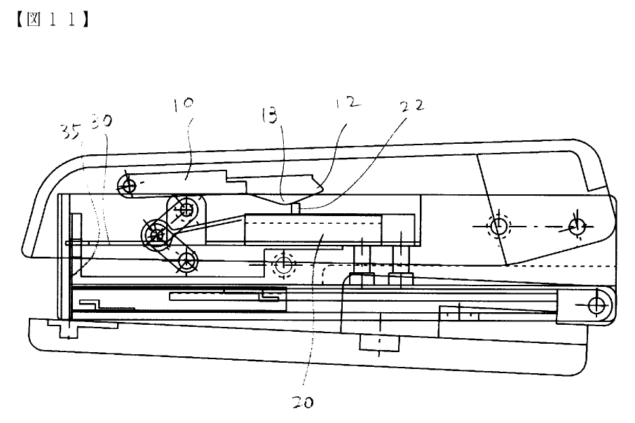

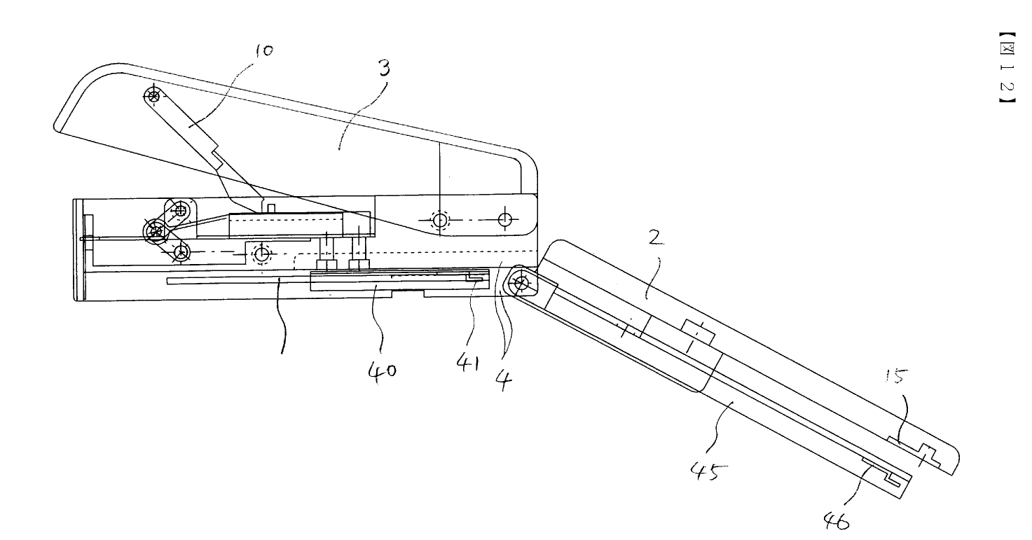

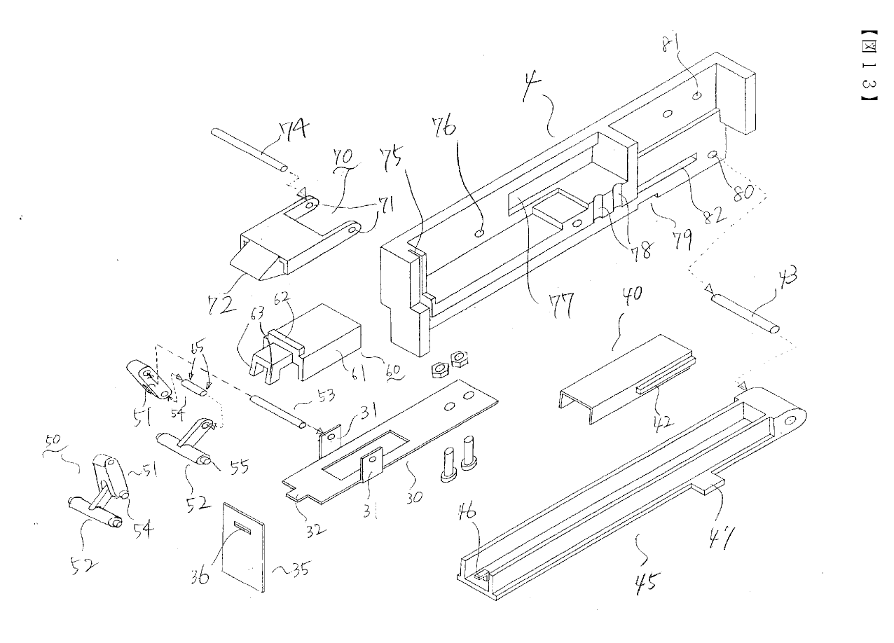

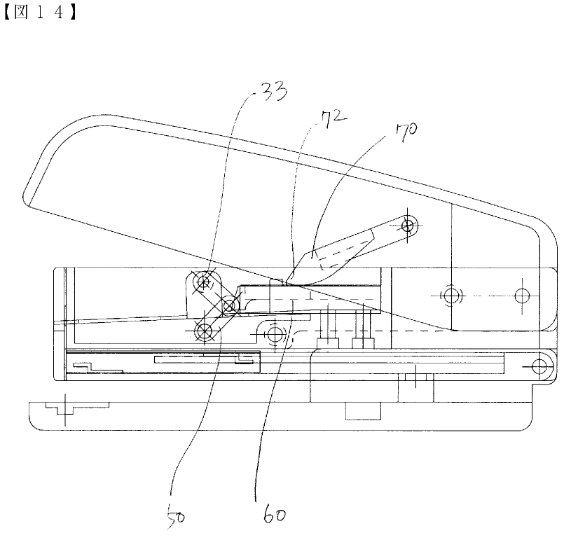

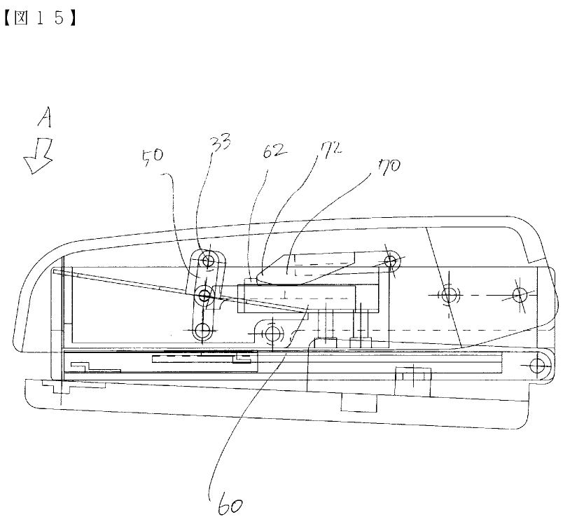

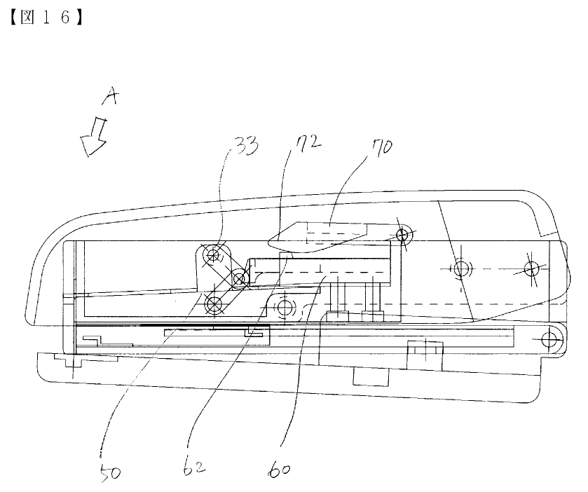

### DESCRIPTION OF THE REFERENCE NUMERALS

1 stapler
2 base
3 handle
4 frame
10 trigger
11 base member
12 tongue A
13 tongue B
15 anvil
20 puller
21 puller legs
22 stopper
30 driver spring
31 upper side projections
32 forward projection
35 blade
36 blade opening
37 blade engaged
38 staple
40 feeder
41 feeder-spring engaging unit
42 feeder-frame engaging unit
43 frame shaft
45 guide
46 guide-spring engaging unit
47 guide base engaging unit
50 toggle
51 joint A
52 joint B
53 toggle driver spring shaft
54 toggle shaft
55 toggle frame pin
60 pusher
61 side wall
62 stopper
63 fore end
65 both ends
70 trigger
71 holes
72 tongue A
74 trigger shaft
75 slit
76 hole
77 window
78 apertures
79 cut-out
80 hole
81 hole
82 groove

What is claimed is:

1. A stapler comprising:
a handle member,
a frame member of which a rear end is pivotably attached to said handle member,
a base member of which a rear end is pivotably attached to said frame member and on which is mounted a guide member,
a feeder member which is linked to said guide member via spring, and pushes a staple which slides along the guide forward by engaging a rail provided on said frame member and sliding back and forth with spanning said guide member,
a driver spring member of which one end is attached to a blade member and another end is attached to said frame member,
a toggle mechanism having a joint a of which one end is a fulcrum shaft A and another end is said fulcrum shaft B, and a joint b of which one end is a fulcrum shaft B and another end is a fulcrum shaft C, the other end of said joint a is pivotably attached to one end of said joint b,
a puller member of which the one end engages said fulcrum shaft B, and
a trigger member of which one end is pivotably attached to said handle member and the distal of another end engages said puller member,
wherein the driver spring member engages said fulcrum shaft A at a place between one end thereof and another end thereof,
said trigger member rotates to push said puller member forward due to the pushing down of said handle, the fulcrum shaft B moves due to the going forward of said puller member, consequently a distance between the fulcrum shaft A and the fulcrum shaft C increases,
in accordance with this, one end of said driver spring moves to the upper side to save power in said driver spring, further pushing down of said handle releases the engagement between the dismal of said trigger member and said puller member and the power saved in said driver spring is temporally released to lift down said fulcrum shaft A, and
the lifting down of the fulcrum shaft A lifts down the blade attached to one end of the driver spring.

2. The stapler according to claim 1, wherein said trigger member rotates to push said puller member backward due to the pushing down of said handle, the fulcrum shaft B moves backward due to the rearward movement of said puller member, consequently a distance between the fulcrum shaft A and the fulcrum shaft C increases.

3. The stapler according to claim 2, wherein the fulcrum shaft B is always located forward of a line linking the fulcrum shaft A and the fulcrum shaft C.

4. The stapler according to claim 2 or 3, wherein a lower side projection is provided forward of the distil of the other end of said trigger member,
said lower side projection of said trigger member keeps the engagement with said puller member continuously even after the engagement between the distil of said trigger member and said puller member is released,
the extinguishment of the force for pushing down said handle lifts up the forward of said handle,
in accordance with the lifting up of the forward of said handle, said trigger member rotates around one end of said trigger member to lift down another end of said trigger member,
in accordance with the lifting down of the other end of said trigger member, the position of the engagement between said trigger member and said puller member moves forward, and
the distil of said trigger member engages said puller member again.

5. The stapler according to claim 1, wherein said trigger member rotates to push said puller member forward due to the pushing down of said handle, the fulcrum shaft B moves forward due to the forward movement of said puller member, consequently a distance between the fulcrum shaft A and the fulcrum shaft C increases.

6. The stapler according to claim 5, wherein the fulcrum shaft B is always located rearward of a line linking the fulcrum shaft A and the fulcrum shaft C.

7. The stapler according to claim 5 or 6, wherein a lower side projection is provided rearward of the distil of the other end of said trigger member,
the lower side projection of said trigger member keeps the engagement with said puller member continuously even after the engagement between the distil of said trigger member and said puller member is released,
the extinguishment of the force for pushing down said handle lifts up the forward of said handle,
in accordance with the lifting up of the forward of said handle, said trigger member rotates around one end of said trigger member to lift down the other end of said trigger member,
in accordance with the lifting down of the other end of said trigger member, the position of the engagement between said trigger member and said puller member moves forward, and
the distil of said trigger member engages said puller member again.
